(19) United States
(12) Patent Application Publication
(10) Pub. No.: US 2004/0147146 A1
(43) Pub. Date: Jul. 29, 2004

(54) Receptacle connector with separable ground fingers

(76) Inventors: Dean Vermeersch, Harrisburg, PA (US); Carl William Rohde, Elizabethtown, PA (US); Steven David Dunwoody, Middletown, PA (US); Mai Loan Tran, Harrisburg, PA (US)

Correspondence Address: Robert J. Kapalka, Tyco Electronics Corporation, Suite 140, 4550 New Linden Hill Road, Wilmington, DE, 19808-2952, US

(21) Appl. No.: 10/352,627

(22) Filed: Jan. 28, 2003

(51) Int. Cl. H01R 4/66

(52) U.S. Cl. 439/108

(57) ABSTRACT

An electrical receptacle connector is provided having a housing with a front face that includes an opening therein. The opening is configured to receive a plug connector. The receptacle connector further includes a ground shield having a face plate with a hole through the face plate. The face plate covers the front face of the housing such that the hole in the face plate aligns with the opening in the front face of the housing. A ground finger is separately mounted to at least one of the ground shield and the housing with a first end of the ground finger extending into the opening in the housing.

### BACKGROUND OF THE INVENTION

The present invention generally relates to electrical connectors for use with high speed serial data, and more particularly, to connector assemblies for transferring high speed serial data from a cable to a circuit board.

In the past, electrical cable assemblies have been proposed for connecting electrical cables to circuit boards. Conventional cable assemblies have been provided with an equalizer circuit board within the connector for performing signal conditioning. Performing signal conditioning within a circuit in the connector assembly, reduces the time required to incorporate signal conditioning circuit elements with a cable assembly and reduces the time required for connection of the circuit elements with the electrical contacts and the cable conductors. One example of a conventional cable assembly with an equalizer board is described in U.S. Pat. No. 5,766,027, commonly owned with the present application, which is incorporated herein in its entirety by reference.

Conventional high speed serial data connectors (HSSDC) comprise a plug and receptacle combination interconnected through contact fingers. HSSDC connectors form a grounding plane surrounding the adjoining surfaces of the receptacle and plug in order to afford electromagnetic interference (EMI) shielding around the contact fingers forming the high speed serial data connection between the plug and receptacle. In conventional HSSDC connectors, EMI shielding is also provided by surrounding the receptacle housing with a ground shield. The ground shield is formed integrally with a plurality of grounding beams on the top, bottom and side walls of the receptacle housing. The ground shield is also formed with grounding beams that are J-shaped integral extensions of the ground shield and are bent to project into the opening of the receptacle. The J-shaped ground beams are biased inward to maintain an electrical connection with the plug once inserted.

U.S. Pat. No. 6,276,943 discloses a conventional HSSDC receptacle connector. The '943 patent illustrates a shield 48 that includes ground tabs 58 which extend into an opening 41 to engage a plug connector shield. The ground tabs 58 are distributed about the interior surfaces of the opening 41.

However, the arrangement of the '943 patent has met with certain limitations. In particular, the degree to which EMI shielding is achieved is in part dependent upon the number of ground tabs and the positions of the ground tabs about the opening. In the '943 patent, the top and bottom ground tabs are located along the top and bottom edges of the opening near the center of the opening which is somewhat remote from the side ground tabs that are located along the side edges of the opening. The wide separation between side ground tabs and the top and bottom ground tabs of the '943 patent is in part necessitated by the fact that the shield is punched from a common, flat sheet of material as all of the side, top and bottom ground tabs. Hence, ground tabs along adjacent edges of the opening (e.g., top and side, or bottom and side) must be distanced sufficiently from one another to avoid overlap in the stamping process. By way of example, the bottom ground tabs must be located a distance from the side edges that is at least as long as the length of the bottom and side ground tabs. Otherwise the outer tips of the side ground tabs would be cut off by the stamp forming the bottom ground tabs, and vice versa.

As data rates continue to increase, the need exists for added EMI shielding about the interface between the plug and receptacle connectors. The shielding capability of the design proposed in the '943 patent is limited by the stamping process and the configuration and geometry of the ground tabs formed with the shield.

A need exists for an improved HSSDC receptacle connector that affords added EMI shielding at the interface between the plug and receptacle connectors.

Moreover, at high data rates, the ground tabs become more inductive. The inductance of the ground tab increases as the ground tab becomes shorter and more narrow. The desire to limit inductance is balanced with the desire to maintain the elastic properties of the ground tab. As ground tabs are shortened and made wider, they become less elastic or spring-like. A need exists for a ground member that is highly elastic, yet exhibits low inductance properties.

It is an object of certain embodiments of the present invention to meet the foregoing need and to overcome problems experienced heretofore.

### BRIEF SUMMARY OF THE INVENTION

An electrical receptacle connector is provided having a housing with a front face that includes an opening configured to receive a plug connector. The receptacle connector further includes a ground shield having a face plate with a hole through the face plate. The face plate covers the front face of the housing such that the hole in the face plate aligns with the opening in the front face of the housing. A ground finger is separately mounted to at least one of the ground shield and the housing with a first end of the ground finger extending into the opening in the housing to interconnect the plug and ground shield.

Optionally, the ground finger may be provided with a body that is held between the outside of the housing and the ground shield. The body may include an intermediate portion that wraps about the front face of the housing, where the intermediate portion is sandwiched between the face plate of the ground shield and the front face of the housing.

The ground shield may further include a ground beam formed integral with the face plate proximate an edge of the hole through the face plate. The ground finger and the ground beam extend along interior surfaces of adjacent interior walls of the opening in the housing. Optionally, the face plate may include side, top and bottom portions aligned in a common plane and surrounding the hole through the face plate. At least one of the side, top and bottom portions may hold the ground finger against the housing.

In accordance with an alternative embodiment, an electrical receptacle connecter is provided having a housing with walls surrounding a plug reception chamber that opens onto a front face of the housing. A ground shield is provided over at least one of the walls and/or the front face. The ground shield is integrally formed with a ground beam that is bent to extend into the plug receptacle chamber. A ground finger is also provided that is separately attached to at least one of the walls, the front face and the ground shield. The ground finger extends into the chamber as well.

Optionally, the ground beam and ground finger may be located along adjacent walls of the plug reception chamber. The ground finger and ground beam may be spaced apart from one another by a distance that is less than a length of the ground beam and/or ground finger, where the lengths of the ground beam and ground finger are measured from outer ends thereof to the hole through the ground shield.

### BRIEF DESCRIPTION OF SEVERAL VIEWS OF THE DRAWINGS

FIG. 1 illustrates a front view of a receptacle connecter formed in accordance with an embodiment of the present invention.

FIG. 2 illustrates an isometric view of a receptacle connector formed in accordance with an embodiment of the present invention with the ground fingers removed.

FIG. 3 illustrates an isometric view of a receptacle housing formed in accordance with an embodiment of the present invention with the ground fingers and ground shield removed.

FIG. 4 illustrates an isometric view of a ground finger formed in accordance with an embodiment of the present invention.

FIG. 5 illustrates a top sectional view taken along line 5-5 in FIG. 1 of the receptacle connector of FIG. 1.

FIG. 6 illustrates a side sectional view taken along line 6-6 in FIG. 1 of the receptacle connector of FIG. 1.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

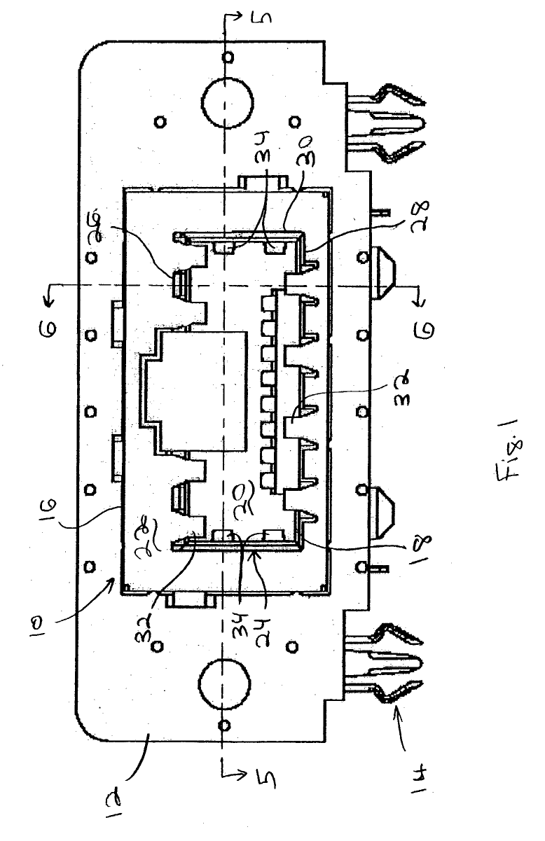

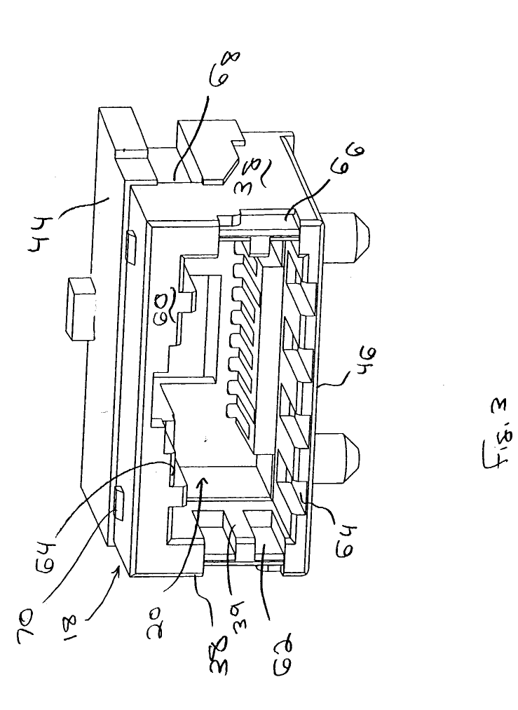

FIG. 1 illustrates a receptacle connector 10 mounted in a die-cast bracket 12 that is configured to be joined through posts 14 to a panel of a chassis or other enclosure and to support the receptacle connector 10. The receptacle connector 10 includes a ground shield 16 that surrounds at least a portion of a receptacle housing 18 (better shown in FIG. 3). The receptacle housing 18 includes a chamber 20 configured to receive a plug connector. The ground shield 16 includes a face plate 22 that has a hole 24 cut therethrough in alignment with the opening of the chamber 20 when the face plate 22 is mounted to the receptacle housing 18. The hole 24 is bounded by a top edge 26, a bottom edge 28 and side edges 30. The top and bottom edges 26 and 28 are formed integrally with ground beams 32 that extend into the chamber 20. The chamber 20 also receives separable ground fingers 34 along opposite sides thereof.

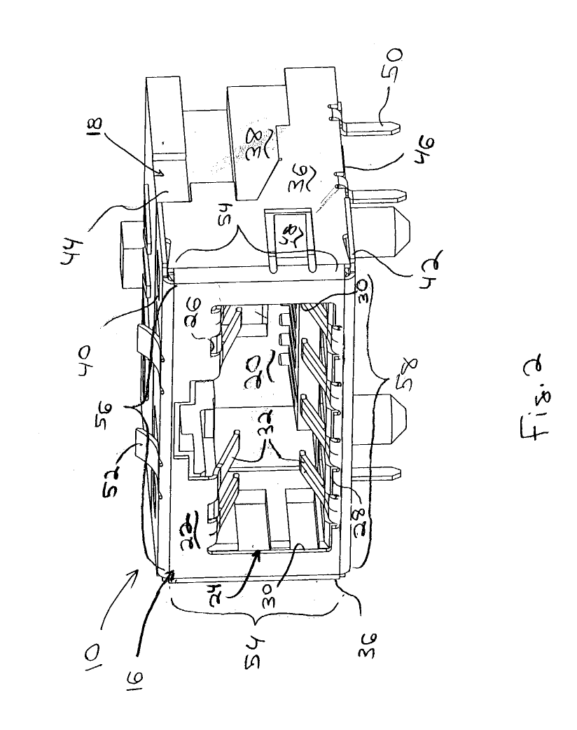

FIG. 2 illustrates an isometric view of the receptacle connector 10 with the ground fingers 34 (FIG. 1) removed. As better shown in FIG. 2, the ground shield 16 includes side flanges 36 formed integrally with the face plate 22. The side flanges 36 are bent rearward to enclose (at least partially) side walls 38 of the receptacle housing 18. The ground shield 16 also includes top and bottom flanges 40 and 42 that are similarly formed integral with the face plate 22 and bent rearward to at least partially enclose the top and bottom walls 44 and 46 of the receptacle housing 18. The face plate 22, side flanges 36, top flange 40 and bottom flange 42 afford a desired amount of EMI shielding to reduce attenuation of high-speed serial data signals.

The side flanges 36 include ground arms 48 stamped therein and projecting outward to engage the bracket 12 (FIG. 1) once mounted. The side flanges 36 also include tabs 50 extending downward from the lower edges of the side flanges 36. The tabs 50 are configured to be received in holes in a circuit board, where the holes are connected to ground traces in the circuit board. Optionally, the tabs 50 may be removed and the ground shield may be surface mounted to a circuit board or other structure. The top flange 40 also includes grounding arms 52 extending upward that are intended to engage the bracket 12.

The face plate 22 is generally composed of side portions 54, a top portion 56 and a bottom portion 58 that include side, top and bottom edges 30, 26 and 28, respectively, that collectively define the hole 24. The top and bottom edges 26 and 28 are integrally formed with ground beams 32 that are bent to extend into the chamber 20.

FIG. 3 illustrates the receptacle housing 18 in more detail to better show the side walls 38, top wall 44 and bottom wall 46. The receptacle housing 18 also includes a front face 60 onto which the chamber 20 opens. The interior surfaces 39 of the side walls 38 include notches 62 that extend rearward from the front face 60. The interior surfaces of the top and bottom walls 44 and 46 also include notches 64 configured to receive corresponding ground beams 32 (FIG. 2). The exterior surfaces of the side walls 38 include cavities 66 cut therein and extending rearward from the front face 60. The cavities 66 are located on the exterior surface opposite to corresponding notches 62 provided on the interior surface 39 of the associated sidewall 38. The notches 62 and cavities 66 are configured to receive ground fingers 34 (FIG. 1) as explained below in more detail.

The side walls 38 also include ledges 68 cut inward and located remote from the front face 60. The ledges 68 receive latching features on the ground shield 16 to retain the ground shield 16. Optionally, the top wall 44 may include tabs 70 that extend upward to engage and assist in retaining the ground shield 16.

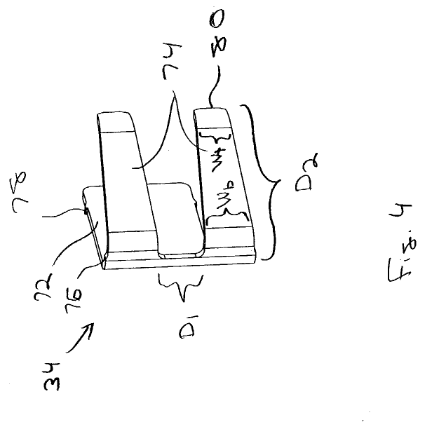

FIG. 4 illustrates an isometric view of a ground finger 34. The ground finger 34 includes a body 72 that is formed integrally with ground beams 74 at an intermediate (bent) portion 76. The body 72 includes barbs 78 on opposite edges thereof that are configured to be received securely by border edges of the cavity 66 (FIG. 3). The ground beams 74 are bent to form generally a U-shape with the body 72. Once inserted, the body 72 is retained securely within the cavity 66, while the intermediate portion 76 wraps around the front face 60 at the side walls 38 (FIG. 3). The ground beams 74 extend acutely into the chamber 20 through the notches 62. The ground beams 74 are spaced apart by a distance D1 that may be varied to distribute the ground beams 74 along the interior surfaces of the side walls 38 as desired. Optionally, only one ground beam 74 may be provided or alternatively more than two ground beams may be formed integral with a single body 72. The ground beams 74 have outer tips 80 that are spaced a distance D2 from the bent intermediate portion 76. The distance D2 may be varied depending upon the depth of the chamber 20 and the positioning of shielding upon the plug connector. The ground beams 74 are tapered along their length to afford a wide base denoted W_{b} and a narrower tip denoted Wₜ.

The distance D2 is maintained sufficient to provide a cantilever spring design for the ground beams 74. By maintaining a desired distance D2 with each ground beam 84, the mechanical reliability is improved and the ground beams 84 remain fully elastic for a longer working life. The width W_{b} at the base of the ground beams 84 is maintained sufficient in order that the inductive properties of the ground finger 34 is reduced.

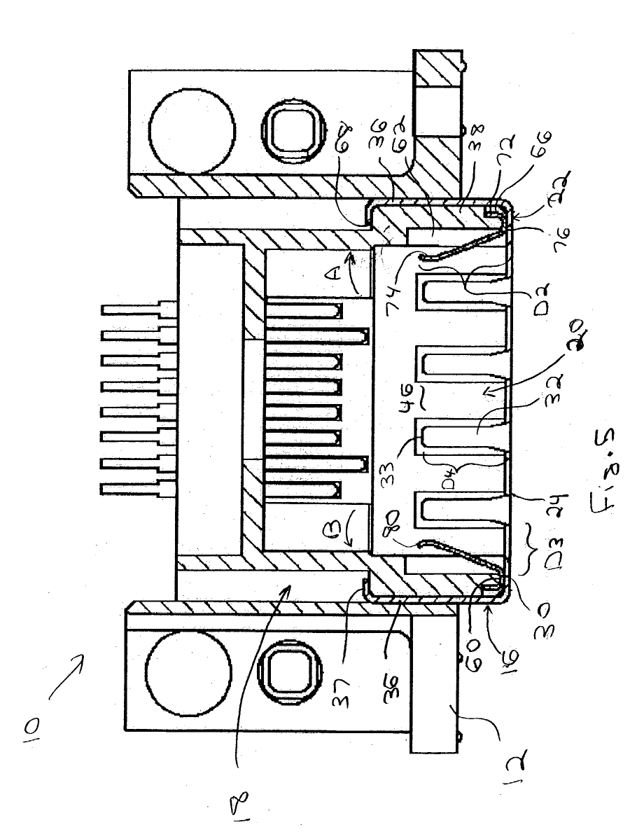

FIG. 5 illustrates a top sectional view taken along line 5-5 of FIG. 1 of the receptacle connector 10 when mounted in the bracket 12. The body 72 of each ground finger 34 is held within cavities 66, and thus is only partially shown, while the bent intermediate portion 76 is pitched or sandwiched between the front face 60 at the sidewall 38 and the face plate 22 of the ground shield 16. The ground beams 74 extend the distance D2 into the chamber 20, where D2 is measured from the bent intermediate portion 76 (which corresponds to the position of the face plate 22 and ground face 60) to the outer tip 80.

When a plug connector is inserted, the ground beams 74 are deflected in the directions of arrow A and B which tend to bias the body 72 outward toward the side flanges 36 on the ground shield 18. The side flanges 36 and the frictional engagement between barbs 78 (FIG. 4) and the edges of cavities 66 hold the bodies 72 in a desired position relative to the receptacle housing 18 as the ground beams 74 are deflected toward notches 62.

As shown in FIG. 5, a plurality of ground beams 32 may be provided along the interior surface of the bottom wall 46. The ground beams 32 are spaced a distance D3 from the side edge 30 of the hole 24 in the face plate 22. The ground beams 32 have outer tips 33 that extend a distance D4 from the face plate 22. The distances D4 and D2 corresponding to the lengths of the ground beams 32 and ground fingers 34, respectively, are longer than the spacing between the ground beams 32 and the side edges 30 of the hole 24 to afford a more dense configuration of grounding beams and fingers 32 and 34, thereby improving the EMI shielding at the interface between the plug and receptacle.

As shown in FIG. 5, the side flanges 36 include latching tips 37 that are formed on outer ends to engage securely the ledges 68 formed in the side walls 38. In this manner, the ground shield 16 is securely retained against the front face 60 of the receptacle housing 18.

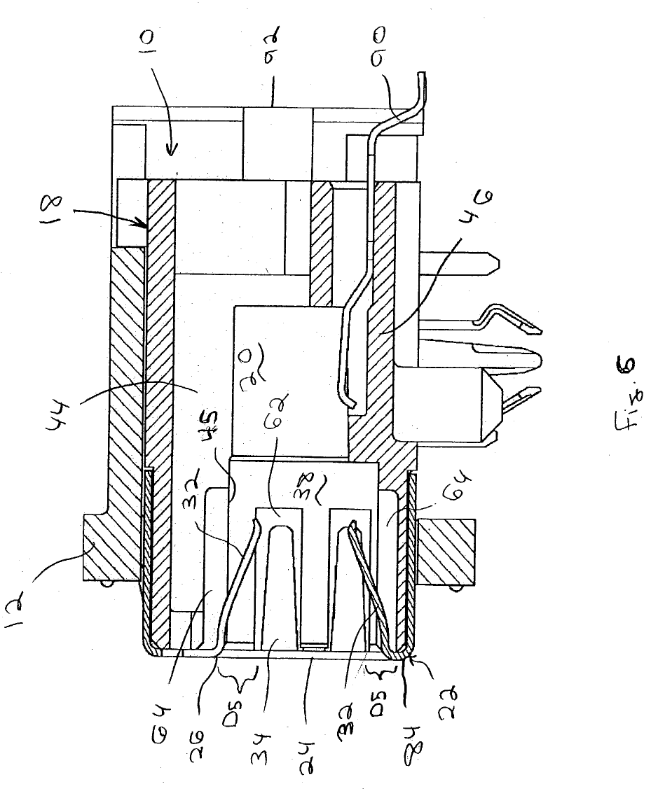

FIG. 6 illustrates a side sectional view taken along line 6-6 in FIG. 1 of the receptacle connector 10 while mounted in the bracket 12. As shown in FIG. 6, the ground beams 32 are formed integrally at elbows 84 with the face plate 22. The ground beams 32 are deflectable toward notches 64 in the top and bottom walls 44 and 46. The ground fingers 34 are received in notches 62 in the sidewall 38. The ground fingers 34 are spaced a distance D5 from the top and bottom edges 26 and 28 of the hole 24. The distance D5 between the ground fingers 34 and the top and bottom edges 26 and 28 is less than the lengths D2 and D4 of the ground fingers 34 and ground beams 32.

FIG. 6 also illustrates a contact 90 held within chamber 20 and extending from a rear end 92 of the receptacle connector 10. One or more rows of contacts 90 are configured to join with corresponding contacts in the plug connector when inserted into the chamber 20.

The ground fingers 34 are provided as separate and distinct components from the ground shield 16 to avoid the need to stamp, from the ground shield 16, ground beams 32 along adjacent edges of the hole 24. Optionally, the ground beams 32 may be formed integral with the side edges 30 of the hole 24, while the separate ground fingers 34 may be provided proximate the top and bottom walls 44 and 46 of the receptacle housing 18.

The number of grounding beams and grounding fingers may be reduced or increased depending upon the data rate to be supported by the receptacle connector and EMI reduction desired.

While the invention has been described with reference to certain embodiments, it will be understood by those skilled in the art that various changes may be made and equivalents may be substituted without departing from the scope of the invention. In addition, many modifications may be made to adapt a particular situation or material to, the teachings of the invention without departing from its scope. Therefore, it is intended that the invention not be limited to the particular embodiment disclosed, but that the invention will include all embodiments falling within the scope of the appended claims.

1. An electrical receptacle connector, comprising:
a housing having a front face with an opening therein, said opening being configured to receive a plug connector;
a ground shield having a face plate with a hole through said face plate, said face plate covering said front face of said housing such that said hole aligns with said opening; and
a ground finger separately mounted to at least one of said ground shield and said housing with a first end of said ground finger extending into said opening.

2. The receptacle connector of claim 1, wherein said ground finger includes a body that is held between said housing and said ground shield.

3. The receptacle connector of claim 1, wherein said ground finger includes an intermediate portion wrapped about said front face of said housing, said intermediate portion being sandwiched between said face plate and said front face of said housing.

4. The receptacle connector of claim 1, wherein said ground finger includes a second end held in a cavity formed in an exterior surface of a wall of said housing.

5. The receptacle connector of claim 1, wherein said first end of said ground finger includes a pair of forked ground beams that extend into said opening, said pair of ground beams being formed with a body of said ground finger, said body wrapping about said front face of said housing.

6. The receptacle connector of claim 1, wherein said housing includes a side wall having a channel notched in an interior surface of said side wall, said channel receiving said ground finger.

7. The receptacle connector of claim 1, wherein said ground shield includes a ground beam formed integrally with said face plate at an edge of said hole, said ground finger and ground beam extending along interior surfaces of adjacent walls of said opening in said housing.

8. The receptacle connector of claim 1, wherein said ground shield includes side flanges formed with said face plate, said side flanges being bent to overlap side walls of said housing, said ground finger being held between one of said side flanges a corresponding side wall.

9. The receptacle connector of claim 1, wherein said face plate includes side, top and bottom portions aligned in a common plane and surrounding said hole, at least one of said side, top and bottom portions holding said ground finger against said housing.

10. The receptacle connector of claim 1, wherein said face plate includes side, top and bottom portions aligned in a common plane and surrounding said hole, at least one of said side, top and bottom portions being formed integral with a ground beam, while an adjacent one of said side, top and bottom portions abuts against, and is formed separate from, said ground finger.

11. The receptacle connector of claim 1, wherein said ground finger includes a ground beam that is tapered with a wide beam base and a narrow beam outer tip.

12. The receptacle connector of claim 1, wherein said ground finger includes at least two tapered ground beams joined at one end proximate said front face of said housing.

13. An electrical receptacle connector, comprising:
a housing having walls surrounding a plug reception chamber that opens onto a front face of said housing;
a ground shield provided over at least one of said front face and a wall of said housing, said ground shield being integrally formed with a ground beam bent to extend into said plug reception chamber; and
a ground finger separably joined with said ground shield, said ground finger extending into said plug reception chamber.

14. The receptacle connector of claim 13, wherein said ground beam and ground finger are located along adjacent walls surrounding said plug reception chamber.

15. The receptacle connector of claim 11, wherein said ground beam and finger extend first and second lengths from said front wall into said plug reception chamber and are located along first and second walls of said housing, respectively, said ground finger being positioned along said second wall a distance from said first wall that is less than said length of said ground beam.

16. The receptacle connector of claim 11, wherein said ground beam and finger extend into said plug reception chamber along adjacent walls and are located a distance from one another that is less than a length of at least one of said ground beam and ground finger, said length being measured from a face plate of said ground shield to an end of a corresponding one of said ground beam and finger into said plug receptacle chamber.

17. The receptacle connector of claim 13 wherein said ground finger includes a ground beam that is tapered with a wide beam base and a narrow beam outer tip.

18. The receptacle of connector of claim 13, wherein said ground finger includes at least two tapered ground beams joined at one end proximate said front face of said housing.

19. The receptacle connector of claim 13, wherein said ground finger includes a body held between an exterior of said housing and said ground shield.

20 The receptacle connector of claim 13, wherein said ground finger includes a pair of ground beams extending from a base, said base and said pair of ground beams wrapping about one of said walls at said front face.
